(19) United States
(12) Patent Application Publication
(10) Pub. No.: US 2009/0312479 A1
(43) Pub. Date: Dec. 17, 2009

(54) POLYCARBONATE COMPOSITIONS

(75) Inventors: Yu Ren, Shanghai (CN); Chunjie Zhang, Shanghai (CN); Robert Puyenbroek, Bergen op Zoom (NL)

Correspondence Address: SABIC - LEXAN;SABIC Innovative Plastics - IP Legal, ONE PLASTICS AVE., PITTSFIELD, MA, 01201-3697, US

(73) Assignee: SABIC INNOVATIVE PLASTICS IP BV, Bergen op Zoom (NL)

(21) Appl. No.: 12/140,841

(22) Filed: Jun. 17, 2008

(51) Int. Cl. C08L 69/00; C08K 3/34

(52) U.S. Cl. 524/451; 524/537

(57) ABSTRACT

Polycarbonate compositions having an improved balance of physical properties, particularly tensile modulus, impact strength, and flow properties, are disclosed. The compositions comprise a polycarbonate polymer, an impact modifier, a non-glass filler, and an alicyclic hydrocarbon resin. They may further comprise an acrylate polymer and an organic phosphate.

### BACKGROUND

The present disclosure relates to polycarbonate compositions having, among other characteristics, high tensile modulus and ductility. In particular, the disclosure relates to polycarbonate compositions, and polycarbonate blends thereof, having improved tensile modulus, impact performance, and/or flow properties. Also included herein are methods for preparing and/or using the same, as well as articles formed from such compositions/blends.

Polycarbonates (PC) are synthetic thermoplastic resins derived from bisphenols and phosgenes, or their derivatives. They are linear polyesters of carbonic acid and can be formed from dihydroxy compounds and carbonate diesters, or by ester interchange. Polymerization may be in aqueous, interfacial, or in nonaqueous solution. Polycarbonates are a useful class of polymers having many desired properties. They are highly regarded for optical clarity and enhanced impact resistance and ductility at room temperature or below.

Impact modifiers are incorporated into polymeric resins to improve the impact strength of finished articles made from such resins. Exemplary impact modifiers include acrylonitrile-butadiene-styrene (ABS) and methacrylate-butadiene-styrene (MBS) polymers. ABS and MBS polymers are synthetic thermoplastic resins made by polymerizing acrylonitrile or methacrylate, respectively, with styrene in the presence of polybutadiene. The properties of ABS and MBS can be modified by varying the relative proportions of the basic components, the degree of grafting, the molecular weight, etc. Overall, ABS and MBS are generally strong, and lightweight thermoplastics.

Blends of polycarbonates with ABS or MBS, or PC/ABS or PC/MBS blends, are also well-known. For example, SABIC Innovative Plastics provides such blends commercially under the brand name CYCOLOY®. These amorphous thermoplastic blends have many desired properties and/or characteristics, including high impact strength, heat resistance, good processability, weather and ozone resistance, good ductility, electrical resistance, aesthetic characteristics, etc. They are widely used in the automotive market, for producing appliance and electrical components, decorative articles, medical devices, and office and business equipment such as computer housings, cell phone casings, etc.

There remains a need in the art for thermoplastic polycarbonate compositions having improved tensile modulus and flow properties. Desirable features of such materials include, among others, excellent mechanical properties and ease of manufacture.

### BRIEF DESCRIPTION

Disclosed, in various embodiments, are polycarbonate compositions, and/or blends thereof, that have an improved combination of mechanical and/or processing properties. Methods for preparing and/or using the same, such as for forming articles which are stable under relatively high temperature conditions, are also disclosed.

In embodiments, a polymer composition is disclosed which comprises: a polycarbonate polymer; an impact modifier; a non-glass filler; and an alicyclic hydrocarbon resin; wherein the polymer composition has a melt viscosity of 420 Pa·sec or less when measured at 260° C. and 1500 sec⁻¹, and a notched Izod impact strength of about 200 J/m or greater when measured at 23° C. according to ASTM D256.

The alicyclic hydrocarbon resin may comprise 10 weight percent or less of the composition, including from about 2 to about 8 weight percent of the composition. The filler may comprise from about 5 to about 20 weight percent of the composition. The impact modifier may comprise from about 2 to about 12 weight percent of the composition.

In some embodiments, the polymer composition may further comprise a polycarbonate-polysiloxane copolymer. The polycarbonate-polysiloxane copolymer may comprise less than about 20 weight percent of the composition, including less than about 15 weight percent and from about 6 to about 15 weight percent of the composition.

In other embodiments, the polymer composition may further comprise an acrylate polymer or an organic phosphate selected from the group consisting of bisphenol-A bis(diphenylphosphate), resorcinol bis(diphenylphosphate), and triphenyl phosphate. In some embodiments, the polymer composition further comprises both the acrylate polymer and the organic phosphate. The weight ratio of acrylate polymer to alicyclic hydrocarbon resin is from about 1:10 to about 10:1. The weight ratio of organic phosphate to alicyclic hydrocarbon resin is from about 1:10 to about 10:1. The acrylate polymer and the organic phosphate together may comprise from about 3 to about 20 weight percent of the composition.

The impact modifier can be selected from the group consisting of acrylonitrile-butadiene-styrene (ABS) polymers and methacrylate-butadiene-styrene (MBS) polymers. The filler may be talc. The polymer composition may further comprise a flame retardant or an antidrip agent as well.

The polymer composition may have a melt viscosity of 365 Pa·sec or less, when measured at 260° C. and 1500 sec⁻¹; a tensile modulus of from about 2600 MPa to about 4800 MPa, according to ASTM D638; and/or a notched Izod impact strength of about 400 J/m or greater when measured at 23° C. according to ASTM D256.

In other embodiments, a polymer composition is disclosed which comprises: a polycarbonate polymer; an impact modifier; a mineral filler; an alicyclic hydrocarbon resin; and either an acrylate polymer or an organic phosphate selected from the group consisting of bisphenol-A bis(diphenylphosphate), resorcinol bis(diphenylphosphate), and triphenyl phosphate; wherein the polymer composition has a melt viscosity of 420 Parsec or less when measured at 260° C. and 1500 sec¹, a tensile modulus of from about 3000 MPa to about 3800 MPa according to ASTM D638, and a notched Izod impact strength of about 400 J/m or greater when measured at 23° C. according to ASTM D256.

In yet other embodiments, a polymer composition is disclosed which comprises: a polycarbonate polymer; an impact modifier comprising from about 2 to about 12 weight percent of the composition; a non-glass filler comprising from about 5 to about 20 weight percent of the composition; an alicyclic hydrocarbon resin comprising from about 2 to about 8 weight percent of the composition; an acrylate polymer; and bisphenol-A bis(diphenylphosphate);

wherein the acrylate polymer and bisphenol-A bis(diphenylphosphate) together comprise from about 3 to about 20 weight percent of the composition; and

wherein the wherein the polymer composition has a melt viscosity of 365 Pa·sec or less, when measured at 260° C. and 1500 sec¹; a tensile modulus of from about 3000 MPa to about 3800 MPa according to ASTM D638; and a notched Izod impact strength of about 400 J/m or greater when measured at 23° C. according to ASTM D256.

Articles formed from the polycarbonate compositions are also disclosed.

These and other non-limiting features or characteristics of the present disclosure will be further described below

### DETAILED DESCRIPTION

Numerical values in the specification and claims of this application, particularly as they relate to polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

The present disclosure may be understood more readily by reference to the following detailed description of desired embodiments and the examples included therein. In the following specification and the claims which follow, reference will be made to a number of terms which shall be defined to have the following meanings.

The singular forms “a,” “an,” and “the” include plural referents unless the context clearly dictates otherwise. All ranges disclosed herein are inclusive of the recited endpoint and independently combinable (for example, the range of “from 2 grams to 10 grams” is inclusive of the endpoints, 2 grams and 10 grams, and all the intermediate values).

The modifier “about” used in connection with a quantity is inclusive of the stated value and has the meaning dictated by the context (for example, it includes at least the degree of error associated with the measurement of the particular quantity).

The term “integer” means a whole number and includes zero. For example, the expression “n is an integer from 0 to 4” means n may be any whole number from 0 to 4, including 0.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, the aldehyde group —CHO is attached through the carbon of the carbonyl group.

The term “aliphatic” refers to a linear or branched array of atoms that is not cyclic and has a valence of at least one. Aliphatic groups are defined to comprise at least one carbon atom. The array of atoms may include heteroatoms such as nitrogen, sulfur, silicon, selenium and oxygen or may be composed exclusively of carbon and hydrogen (“Alkyl”). Aliphatic groups may be substituted or unsubstituted. Exemplary aliphatic groups include, but are not limited to, methyl, ethyl, isopropyl, isobutyl, chloromethyl, hydroxymethyl (—CH₂OH), mercaptomethyl (—CH₂SH), methoxy, methoxycarbonyl (CH₃OCO—), nitromethyl (—CH₂NO₂), and thiocarbonyl.

The term “alkyl” refers to a linear or branched array of atoms that is composed exclusively of carbon and hydrogen. The array of atoms may include single bonds, double bonds, or triple bonds (typically referred to as alkane, alkene, or alkyne). Alkyl groups may be substituted or unsubstituted. Exemplary alkyl groups include, but are not limited to, methyl, ethyl, and isopropyl.

The term “aromatic” refers to an array of atoms having a valence of at least one and comprising at least one aromatic group. The array of atoms may include heteroatoms such as nitrogen, sulfur, selenium, silicon and oxygen, or may be composed exclusively of carbon and hydrogen. The aromatic group may also include nonaromatic components. For example, a benzyl group is an aromatic group that comprises a phenyl ring (the aromatic component) and a methylene group (the nonaromatic component). Exemplary aromatic groups include, but are not limited to, phenyl, pyridyl, furanyl, thienyl, naphthyl, biphenyl, 4-trifluoromethylphenyl, 4-chloromethylphen-1-yl, and 3-trichloromethylphen-1-yl (3-CCl₃Ph-).

The terms “cycloaliphatic” and “alicyclic” refer to an array of atoms which is cyclic but which is not aromatic. The cycloaliphatic group may include heteroatoms such as nitrogen, sulfur, selenium, silicon and oxygen, or may be composed exclusively of carbon and hydrogen. A cycloaliphatic group may comprise one or more noncyclic components. For example, a cyclohexylmethyl group (C₆H₁₁CH₂) is a cycloaliphatic functionality, which comprises a cyclohexyl ring (the array of atoms which is cyclic but which is not aromatic) and a methylene group (the noncyclic component). Exemplary cycloaliphatic groups include, but are not limited to, cyclopropyl, cyclobutyl, 1,1,4,4-tetramethylcyclobutyl, piperidinyl, and 2,2,6,6-tetramethylpiperydinyl.

In embodiments, the polymer compositions of the present disclosure comprise (A) a polycarbonate polymer; (B) an impact modifier; (C) a non-glass filler; and (D) an alicyclic hydrocarbon resin. The polymer composition is a blend of a the components (A), (B), (C), and (D).

As used herein, the terms “polycarbonate” and “polycarbonate polymer” mean compositions having repeating structural carbonate units of the formula (1):

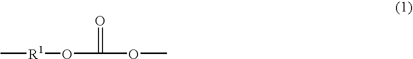

in which at least about 60 percent of the total number of R¹ groups are aromatic organic radicals and the balance thereof are aliphatic, alicyclic, or aromatic radicals. In one embodiment, each R¹ is an aromatic organic radical, for example a radical of the formula (2):

-A¹-Y¹-A²- (2)

wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, wherein R¹ is as defined above. Dihydroxy compounds suitable in an interfacial reaction include the dihydroxy compounds of formula (A) as well as dihydroxy compounds of formula (3)

HO-A¹-Y¹-A²-OH (3)

wherein Y¹, A¹ and A² are as described above. Also included are bisphenol compounds of general formula (4):

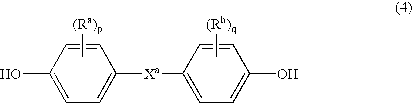

wherein R^{a} and R^{b} each represent a halogen atom or a monovalent hydrocarbon group and may be the same or different; p and q are each independently integers of 0 to 4; and X^{a} represents one of the groups of formula (5):

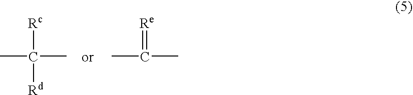

wherein R^{c} and R^{d} each independently represent a hydrogen atom or a monovalent linear or cyclic hydrocarbon group and R^{e} is a divalent hydrocarbon group.

Some illustrative, non-limiting examples of suitable dihydroxy compounds include the following: resorcinol, 4-bromoresorcinol, hydroquinone, 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, and the like, as well as combinations comprising at least one of the foregoing dihydroxy compounds.

Specific examples of the types of bisphenol compounds that may be represented by formula (3) include 1,1-bis(4-hydroxyphenyl) methane, 1,1-bis(4-hydroxyphenyl)ethane, 2,2-bis(4-hydroxyphenyl) propane (hereinafter “bisphenol-A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, and 1,1-bis(4-hydroxy-t-butylphenyl) propane. Combinations comprising at least one of the foregoing dihydroxy compounds may also be used.

Branched polycarbonates are also useful, as well as blends of a linear polycarbonate and a branched polycarbonate. The branched polycarbonates may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents may be added at a level of about 0.05 wt % to about 2.0 wt %. All types of polycarbonate end groups are contemplated as being useful in the polycarbonate composition, provided that such end groups do not significantly affect desired properties of the thermoplastic compositions.

Suitable polycarbonates can be manufactured by processes such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like. Suitable carbonate precursors include, for example, a carbonyl halide such as carbonyl bromide or carbonyl chloride, or a haloformate such as a bishaloformate of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors may also be used.

Rather than utilizing the dicarboxylic acid per se, it is possible, and sometimes even desired, to employ the reactive derivatives of the acid, such as the corresponding acid halides, in particular the acid dichlorides and the acid dibromides. Thus, for example, instead of using isophthalic acid, terephthalic acid, or mixtures thereof, it is possible to employ isophthaloyl dichloride, terephthaloyl dichloride, and mixtures thereof.

Among the phase transfer catalysts that may be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or a C₆₋₁₈ aryloxy group. Suitable phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃-[CH₃(CH₂)₂]₃NX, wherein X is Cl⁻, Br⁻, a C₁₋₈ alkoxy group or a C₆₋₁₈ aryloxy group. An effective amount of a phase transfer catalyst may be about 0.1 to about 10 wt % based on the weight of bisphenol in the phosgenation mixture. In another embodiment an effective amount of phase transfer catalyst may be about 0.5 to about 2 wt % based on the weight of bisphenol in the phosgenation mixture.

Alternatively, melt processes may be used to make the polycarbonates. Generally, in the melt polymerization process, polycarbonates may be prepared by co-reacting, in a molten state, the dihydroxy reactant(s) and a diaryl carbonate ester, such as diphenyl carbonate, in the presence of a transesterification catalyst in a Banbury® mixer, twin screw extruder, or the like to form a uniform dispersion. Volatile monohydric phenol is removed from the molten reactants by distillation and the polymer is isolated as a molten residue.

“Polycarbonates” and “polycarbonate polymers” as used herein further includes blends of polycarbonates with other copolymers comprising carbonate chain units. An exemplary copolymer is a polyester carbonate, also known as a copolyester-polycarbonate. Such copolymers further contain, in addition to recurring carbonate chain units of the formula (1), repeating units of formula (6)

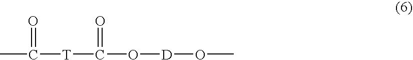

wherein D is a divalent radical derived from a dihydroxy compound, and may be, for example, a C₂₋₁₀ alkylene radical, a C₆₋₂₀ alicyclic radical, a C₆₋₂₀ aromatic radical or a polyoxyalkylene radical in which the alkylene groups contain 2 to about 6 carbon atoms, specifically 2, 3, or 4 carbon atoms; and T is a divalent radical derived from a dicarboxylic acid, and may be, for example, a C₂₋₁₀ alkylene radical, a C₆₋₂₀ alicyclic radical, a C₆₋₂₀ alkyl aromatic radical, or a C₆₋₂₀ aromatic radical.

In one embodiment, D is a C₂₋₆ alkylene radical. In another embodiment, D is derived from an aromatic dihydroxy compound of formula (7):

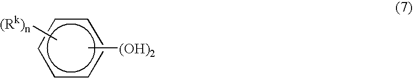

wherein each R^{k} is independently a halogen atom, a C₁₋₁₀ hydrocarbon group, or a C₁₋₁₀ halogen substituted hydrocarbon group, and n is 0 to 4. The halogen is usually bromine. Examples of compounds that may be represented by the formula (7) include resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like; or combinations comprising at least one of the foregoing compounds.

Examples of aromatic dicarboxylic acids that may be used to prepare the polyesters include isophthalic or terephthalic acid, 1,2-di(p-carboxyphenyl)ethane, 4,4′-dicarboxydiphenyl ether, 4,4′-bisbenzoic acid, and mixtures comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or mixtures thereof. A specific dicarboxylic acid comprises a mixture of isophthalic acid and terephthalic acid wherein the weight ratio of terephthalic acid to isophthalic acid is about 10:1 to about 0.2:9.8. In another specific embodiment, D is a C₂₋₆ alkylene radical and T is p-phenylene, m-phenylene, naphthalene, a divalent cycloaliphatic radical, or a mixture thereof. This class of polyester includes the poly(alkylene terephthalates).

In other embodiments, poly(alkylene terephthalates) may be used. Specific examples of suitable poly(alkylene terephthalates) are poly(ethylene terephthalate) (PET), poly(1,4-butylene terephthalate) (PBT), poly(ethylene naphthanoate) (PEN), poly(butylene naphthanoate), (PBN), (polypropylene terephthalate) (PPT), polycyclohexanedimethanol terephthalate (PCT), and combinations comprising at least one of the foregoing polyesters. Also contemplated are the above polyesters with a minor amount, e.g., from about 0.5 to about 10 percent by weight, of units derived from an aliphatic diacid and/or an aliphatic polyol to make copolyesters.

Copolymers comprising alkylene terephthalate repeating ester units with other ester groups may also be useful. Useful ester units may include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

Poly(cycloalkylene diester)s may also include poly(alkylene cyclohexanedicarboxylate)s. Of these, a specific example is poly(1,4-cyclohexane-dimethanol-1,4-cyclohexanedicarboxylate) (PCCD), having recurring units of formula (8):

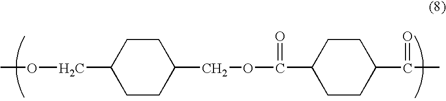

wherein, as described using formula (6), R² is a 1,4-cyclohexanedimethylene group derived from 1,4-cyclohexanedimethanol, and T is a cyclohexane ring derived from cyclohexanedicarboxylate or a chemical equivalent thereof, and may comprise the cis-isomer, the trans-isomer, or a combination comprising at least one of the foregoing isomers.

Another exemplary copolymer comprises polycarbonate blocks and polydiorganosiloxane blocks, also known as a polycarbonate-polysiloxane copolymer. The polycarbonate blocks in the copolymer comprise repeating structural units of formula (1) as described above, for example wherein R¹ is of formula (2) as described above. These units may be derived from reaction of dihydroxy compounds of formula (3) as described above.

The polydiorganosiloxane blocks comprise repeating structural units of formula (9) (sometimes referred to herein as ‘siloxane’):

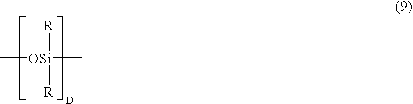

wherein each occurrence of R is same or different, and is a C₁₋₃ monovalent organic radical. For example, R may be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₀ aryl group, C₆-C₁₀ aryloxy group, C₇-C₁₃ aralkyl group, C₇-C₁₃ aralkoxy group, C₇-C₁₃ alkaryl group, or C₇-C₁₃ alkaryloxy group. Combinations of the foregoing R groups may be used in the same copolymer.

The value of D in formula (9) may vary widely depending on the type and relative amount of each component in the thermoplastic composition, the desired properties of the composition, and like considerations. Generally, D may have an average value of 2 to about 1000, specifically about 2 to about 500, more specifically about 5 to about 100. In one embodiment, D has an average value of about 10 to about 75, and in still another embodiment, D has an average value of about 40 to about 60. Where D is of a lower value, e.g., less than about 40, it may be desirable to use a relatively larger amount of the polycarbonate-polysiloxane copolymer. Conversely, where D is of a higher value, e.g., greater than about 40, it may be necessary to use a relatively lower amount of the polycarbonate-polysiloxane copolymer.

A combination of a first and a second (or more) polycarbonate-polysiloxane copolymers may be used, wherein the average value of D of the first copolymer is less than the average value of D of the second copolymer.

In one embodiment, the polydiorganosiloxane blocks are provided by repeating structural units of formula (10):

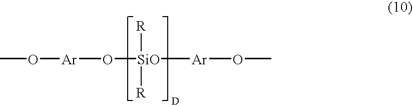

wherein D is as defined above; each R may be the same or different, and is as defined above; and Ar may be the same or different, and is a substituted or unsubstituted C₆-C₃₀ arylene radical, wherein the bonds are directly connected to an aromatic moiety. Suitable Ar groups in formula (10) may be derived from a C₆-C₃₀ dihydroxyarylene compound, for example a dihydroxyarylene compound of formula (3), (4), or (7) above. Combinations comprising at least one of the foregoing dihydroxyarylene compounds may also be used. Specific examples of suitable dihydroxyarlyene compounds are 1,1-bis(4-hydroxyphenyl) methane, 1,1-bis(4-hydroxyphenyl)ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl)cyclohexane, bis(4-hydroxyphenyl sulphide), and 1,1-bis(4-hydroxy-t-butylphenyl) propane. Combinations comprising at least one of the foregoing dihydroxy compounds may also be used.

Such units may be derived from the corresponding dihydroxy compound of the following formula (11):

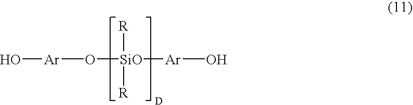

wherein Ar and D are as described above. Such compounds are further described in U.S. Pat. No. 4,746,701 to Kress et al. Compounds of this formula may be obtained by the reaction of a dihydroxyaryiene compound with, for example, an alpha, omega-bisacetoxypolydiorangonosiloxane under phase transfer conditions.

In another embodiment the polydiorganosiloxane blocks comprise repeating structural units of formula (12):

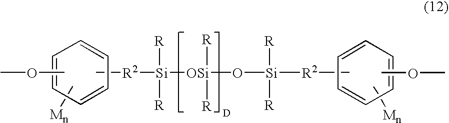

wherein R and D are as defined above. R² in formula (12) is a divalent C₂-C₈ aliphatic group. Each M in formula (12) may be the same or different, and may be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkaryl, or C₇-C₁₂ alkaryloxy, wherein each n is independently 0, 1, 2, 3, or 4.

In one embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R² is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a mixture of methyl and trifluoropropyl, or a mixture of methyl and phenyl. In still another embodiment, M is methoxy, n is one, R² is a divalent C₁-C₃ aliphatic group, and R is methyl.

These units may be derived from the corresponding dihydroxy polydiorganosiloxane (13):

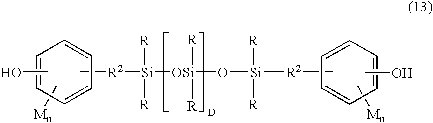

wherein R, D, M, R², and n are as described above.

Such dihydroxy polysiloxanes can be made by effecting a platinum catalyzed addition between a siloxane hydride of the formula (14),

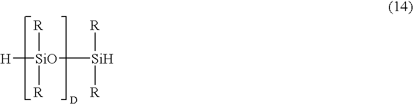

wherein R and D are as previously defined, and an aliphatically unsaturated monohydric phenol. Suitable aliphatically unsaturated monohydric phenols included, for example, eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Mixtures comprising at least one of the foregoing may also be used.

A polycarbonate-polysiloxane copolymer may be manufactured by reaction of diphenolic polysiloxane (13) with a carbonate source and a dihydroxy aromatic compound of formula (3), optionally in the presence of a phase transfer catalyst as described above. Suitable conditions are similar to those useful in forming polycarbonates. For example, the copolymers are prepared by phosgenation, at temperatures from below 0° C. to about 100° C., desirably about 25° C. to about 50° C. Since the reaction is exothermic, the rate of phosgene addition may be used to control the reaction temperature. The amount of phosgene required will generally depend upon the amount of the dihydric reactants. Alternatively, the polycarbonate-polysiloxane copolymers may be prepared by co-reacting in a molten state, the dihydroxy monomers and a diaryl carbonate ester, such as diphenyl carbonate, in the presence of a transesterification catalyst as described above.

In the production of a polycarbonate-polysiloxane copolymer, the amount of dihydroxy polydiorganosiloxane is selected so as to provide the desired amount of polydiorganosiloxane units in the copolymer. The amount of polydiorganosiloxane units may vary widely, i.e., may be about 1 wt % to about 99 wt % of polydimethylsiloxane, or an equivalent molar amount of another polydiorganosiloxane, with the balance being carbonate units. The particular amounts used will therefore be determined depending on desired physical properties of the thermoplastic composition, the value of D (within the range of 2 to about 1000), and the type and relative amount of each component in the thermoplastic composition, including the type and amount of polycarbonate, type and amount of impact modifier, type and amount of polycarbonate-polysiloxane copolymer, and type and amount of any other additives. Suitable amounts of dihydroxy polydiorganosiloxane can be determined by one of ordinary skill in the art without undue experimentation using the guidelines taught herein. For example, the amount of dihydroxy polydiorganosiloxane may be selected so as to produce a copolymer comprising about 1 wt % to about 75 wt %, or about 1 wt % to about 50 wt % polydimethylsiloxane, or an equivalent molar amount of another polydiorganosiloxane. In one embodiment, the copolymer comprises about 5 wt % to about 40 wt %, optionally about 5 wt % to about 25 wt % polydimethylsiloxane, or an equivalent molar amount of another polydiorganosiloxane, with the balance being polycarbonate. In a particular embodiment, the copolymer may comprise about 20 wt % siloxane.

The polycarbonate polymer used in the blend may be a polycarbonate homopolymer or a polyester-polycarbonate copolymer. In more specific embodiments, the polycarbonate polymer (A) used in the blend is a polycarbonate homopolymer.

In specific embodiments, the polycarbonate polymer is derived from a dihydroxy compound having the structure of Formula (I):

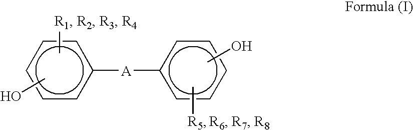

wherein R₁ through R₈ are each independently selected from hydrogen, halogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

In specific embodiments, the dihydroxy compound of Formula (1) is 2,2-bis(4-hydroxyphenyl) propane (i.e. bisphenol-A or BPA). Other illustrative compounds of Formula (I) include:
2,2-bis(3-bromo-4-hydroxyphenyl)propane;
2,2-bis(4-hydroxy-3-methylphenyl)propane;
2,2-bis(4-hydroxy-3-isopropylphenyl)propane;
2,2-bis(3-t-butyl-4-hydroxyphenyl)propane;
2,2-bis(3-phenyl-4-hydroxyphenyl)propane;
2,2-bis(3,5-dichloro-4-hydroxyphenyl)propane;
1,1-bis(4-hydroxyphenyl)cyclohexane;
1,1-bis(3-chloro-4-hydroxyphenyl)-3,3,5-trimethylcyclohexane;
4,4′dihydroxy-1,1-biphenyl;
4,4′-dihydroxy-3,3′-dimethyl-1,1-biphenyl;
4,4′-dihydroxy-3,3′-dioctyl-1,1-biphenyl;
4,4′-dihydroxydiphenylether;
4,4′-dihydroxydiphenylthioether; and
1,3-bis(2-(4-hydroxyphenyl)-2-propyl)benzene.

The polymer composition further comprises one or more impact modifiers (B) to increase the impact strength of the polymer composition.

The impact modifier may include an elastomer-modified graft copolymer comprising (i) an elastomeric (i.e., rubbery) polymer substrate having a Tg less than about 10° C., more specifically less than about −10° C., or more specifically about −40° C. to −80° C., and (ii) a rigid polymeric superstrate grafted to the elastomeric polymer substrate. As is known, elastomer-modified graft copolymers may be prepared by first providing the elastomeric polymer, then polymerizing the constituent monomer(s) of the rigid phase in the presence of the elastomer to obtain the graft copolymer. The grafts may be attached as graft branches or as shells to an elastomer core. The shell may merely physically encapsulate the core, or the shell may be partially or essentially completely grafted to the core.

Suitable materials for use as the elastomer phase include, for example, conjugated diene rubbers; copolymers of a conjugated diene with less than about 50 wt % of a copolymerizable monomer; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl(meth)acrylates; elastomeric copolymers of C₁₋₈ alkyl(meth)acrylates with butadiene and/or styrene; or combinations comprising at least one of the foregoing elastomers. As used herein, the terminology “(meth)acrylate monomers” refers collectively to acrylate monomers and methacrylate monomers.

Suitable conjugated diene monomers for preparing the elastomer phase are of formula (15):

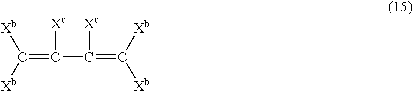

wherein each X^{b} is independently hydrogen, C₁-C₅ alkyl, or the like, and X^{c} is hydrogen. Examples of conjugated diene monomers that may be used are butadiene, isoprene, 1,3-heptadiene, methyl-1,3-pentadiene, 2,3-dimethyl-1,3-butadiene, 2-ethyl-1,3-pentadiene; 1,3- and 2,4-hexadienes, and the like, as well as mixtures comprising at least one of the foregoing conjugated diene monomers. Specific conjugated diene homopolymers include polybutadiene and polyisoprene.

Copolymers of a conjugated diene rubber may also be used, for example those produced by aqueous radical emulsion polymerization of a conjugated diene and one or more monomers copolymerizable therewith. Monomers that are suitable for copolymerization with the conjugated diene include monovinylaromatic monomers containing condensed aromatic ring structures, such as vinyl naphthalene, vinyl anthracene and the like, or monomers of formula (16):

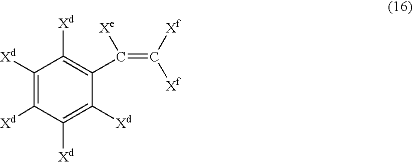

wherein each X^{d} is independently hydrogen, C₁-C₁₂ alkyl, C₃-C₁₂ cycloalkyl, C₆-C₁₂ aryl, C₇-C₁₂ aralkyl, C₇-C₁₂ alkaryl, C₁-C₁₂ alkoxy, C₃-C₁₂ cycloalkoxy, C₆-C₁₂ aryloxy, chloro, bromo, or hydroxy; X^{e} is hydrogen, C₁-C₅ alkyl, bromo, or chloro; and X^{f} is hydrogen. Examples of suitable monovinylaromatic monomers that may be used include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like, and combinations comprising at least one of the foregoing compounds. Styrene and/or alpha-methylstyrene may be used as monomers copolymerizable with the conjugated diene monomer.

Other monomers that may be copolymerized with the conjugated diene are monovinylic monomers such as itaconic acid, acrylamide, N-substituted acrylamide or methacrylamide, maleic anhydride, maleimide, N-alkyl-, aryl-, or haloaryl-substituted maleimide, glycidyl(meth)acrylates, and monomers of the generic formula (17):

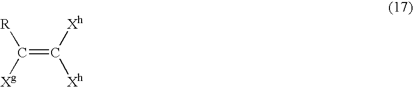

wherein R is hydrogen, C₁-C₅ alkyl, bromo, or chloro; X^{g} is cyano, C₁-C₁₂ alkoxycarbonyl, C₁-C₁₂ aryloxycarbonyl, hydroxy carbonyl, or the like; and X^{h} is hydrogen. Examples of monomers of formula (17) include acrylonitrile, ethacrylonitrile, methacrylonitrile, alpha-chloroacrylonitrile, beta-chloroacrylonitrile, alpha-bromoacrylonitrile, acrylic acid, methyl(meth)acrylate, ethyl(meth)acrylate, n-butyl (meth)acrylate, t-butyl(meth)acrylate, n-propyl(meth)acrylate, isopropyl(meth)acrylate, 2-ethylhexyl(meth)acrylate, and the like, and combinations comprising at least one of the foregoing monomers. Monomers such as n-butyl acrylate, ethyl acrylate, and 2-ethythexyl acrylate are commonly used as monomers copolymerizable with the conjugated diene monomer. Mixtures of the foregoing monovinyl monomers and monovinylaromatic monomers may also be used.

Suitable (meth)acrylate monomers suitable for use as the elastomeric phase may be cross-linked, particulate emulsion homopolymers or copolymers of C₁₋₈ alkyl (meth)acrylates, in particular C₄₋₆ alkyl acrylates, for example n-butyl acrylate, t-butyl acrylate, n-propyl acrylate, isopropyl acrylate, 2-ethylhexyl acrylate, and the like, and combinations comprising at least one of the foregoing monomers. The C₁₋₈ alkyl (meth)acrylate monomers may optionally be polymerized in admixture with up to 15 wt % of comonomers of formulas (15), (16), or (17). Exemplary comonomers include but are not limited to butadiene, isoprene, styrene, methyl methacrylate, phenyl methacrylate, penethylmethacrylate, N-cyclohexylacrylamide, vinyl methyl ether or acrylonitrile, and mixtures comprising at least one of the foregoing comonomers. Optionally, up to 5 wt % a polyfunctional crosslinking comonomer may be present, for example divinylbenzene, alkylenediol di(meth)acrylates such as glycol bisacrylate, alkylenetriol tri(meth)acrylates, polyester di(meth)acrylates, bisacrylamides, triallyl cyanurate, triallyl isocyanurate, allyl (meth)acrylate, diallyl maleate, diallyl fumarate, diallyl adipate, triallyl esters of citric acid, triallyl esters of phosphoric acid, and the like, as well as combinations comprising at least one of the foregoing crosslinking agents.

The elastomer phase may be polymerized by mass, emulsion, suspension, solution or combined processes such as bulk-suspension, emulsion-bulk, bulk-solution or other techniques, using continuous, semibatch, or batch processes. The particle size of the elastomer substrate is not critical. For example, an average particle size of about 0.001 to about 25 micrometers, specifically about 0.01 to about 15 micrometers, or even more specifically about 0.1 to about 8 micrometers may be used for emulsion based polymerized rubber lattices. A particle size of about 0.5 to about 10 micrometers, specifically about 0.6 to about 1.5 micrometers may be used for bulk polymerized rubber substrates. Particle size may be measured by simple light transmission methods or capillary hydrodynamic chromatography (CHDF). The elastomer phase may be a particulate, moderately cross-linked conjugated butadiene or C₄₋₆ alkyl acrylate rubber, and desirably has a gel content greater than 70%. Also suitable are mixtures of butadiene with styrene and/or C₄₋₆ alkyl acrylate rubbers.

The elastomeric phase may provide about 5 wt % to about 95 wt % of the total graft copolymer, more specifically about 20 wt % to about 90 wt %, and even more specifically about 40 wt % to about 85 wt % of the elastomer-modified graft copolymer, the remainder being the rigid graft phase.

The rigid phase of the elastomer-modified graft copolymer may be formed by graft polymerization of a mixture comprising a monovinylaromatic monomer and optionally one or more comonomers in the presence of one or more elastomeric polymer substrates. The above-described monovinylaromatic monomers of formula (16) may be used in the rigid graft phase, including styrene, alpha-methyl styrene, halostyrenes such as dibromostyrene, vinyltoluene, vinylxylene, butylstyrene, para-hydroxystyrene, methoxystyrene, or the like, or combinations comprising at least one of the foregoing monovinylaromatic monomers. Suitable comonomers include, for example, the above-described monovinylic monomers and/or monomers of the general formula (17). In one embodiment, R is hydrogen or C₁-C₂ alkyl, and X^{d} is cyano or C₁-C₁₂ alkoxycarbonyl. Specific examples of suitable comonomers for use in the rigid phase include acrylonitrile, ethacrylonitrile, methacrylonitrile, methyl(meth)acrylate, ethyl(meth)acrylate, n-propyl(meth)acrylate, isopropyl(meth)acrylate, and the like, and combinations comprising at least one of the foregoing comonomers.

The relative ratio of monovinylaromatic monomer and comonomer in the rigid graft phase may vary widely depending on the type of elastomer substrate, type of monovinylaromatic monomer(s), type of comonomer(s), and the desired properties of the impact modifier. The rigid phase may generally comprise up to 100 wt % of monovinyl aromatic monomer, specifically about 30 to about 100 wt %, more specifically about 50 to about 90 wt % monovinylaromatic monomer, with the balance being comonomer(s).

Depending on the amount of elastomer-modified polymer present, a separate matrix or continuous phase of ungrafted rigid polymer or copolymer may be simultaneously obtained along with the elastomer-modified graft copolymer. Typically, such impact modifiers comprise about 40 wt % to about 95 wt % elastomer-modified graft copolymer and about 5 wt % to about 65 wt % graft (co)polymer, based on the total weight of the impact modifier. In another embodiment, such impact modifiers comprise about 50 wt % to about 85 wt %, more specifically about 75 wt % to about 85 wt % rubber-modified graft copolymer, together with about 15 wt % to about 50 wt %, more specifically about 15 wt % to about 25 wt % graft (co)polymer, based on the total weight of the impact modifier.

Another specific type of elastomer-modified impact modifier comprises structural units derived from at least one silicone rubber monomer, a branched acrylate rubber monomer having the formula H₂C═C(R^{g})C(O)OCH₂CH₂R^{h}, wherein R^{g} is hydrogen or a C₁-C₈ linear or branched hydrocarbyl group and R^{h} is a branched C₃-C₁₆ hydrocarbyl group; a first graft link monomer; a polymerizable alkenyl-containing organic material; and a second graft link monomer. The silicone rubber monomer may comprise, for example, a cyclic siloxane, tetraalkoxysilane, trialkoxysilane, (acryloxy)alkoxysilane, (mercaptoalkyl)alkoxysilane, vinylalkoxysilane, or allylalkoxysilane, alone or in combination, e.g., decamethylcyclopentasiloxane, dodecamethylcyclohexasiloxane, trimethyltriphenylcyclotrisiloxane, tetramethyltetraphenylcyclotetrasiloxane, tetramethyltetravinylcyclotetrasiloxane, octaphenylcyclotetrasiloxane, octamethylcyclotetrasiloxane and/or tetraethoxysilane.

Exemplary branched acrylate rubber monomers include iso-octyl acrylate, 6-methyloctyl acrylate, 7-methyloctyl acrylate, 6-methylheptyl acrylate, and the like, alone or in combination. The polymerizable alkenyl-containing organic material may be, for example, a monomer of formula (16) or (17), e.g., styrene, alpha-methylstyrene, acrylonitrile, methacrylonitrile, or an unbranched (meth)acrylate such as methyl methacrylate, 2-ethylhexyl methacrylate, methyl acrylate, ethyl acrylate, n-propyl acrylate, or the like, alone or in combination.

The at least one first graft link monomer may be an (acryloxy)alkoxysilane, a (mercaptoalkyl)alkoxysilane, a vinylalkoxysilane, or an allylalkoxysilane, alone or in combination, e.g., (gamma-methacryloxypropyl)(dimethoxy)methylsilane and/or (3-mercaptopropyl)trimethoxysilane. The at least one second graft link monomer is a polyethylenically unsaturated compound having at least one allyl group, such as allyl methacrylate, triallyl cyanurate, or triallyl isocyanurate, alone or in combination.

The silicone-acrylate impact modifier compositions can be prepared by emulsion polymerization, wherein, for example at least one silicone rubber monomer is reacted with at least one first graft link monomer at a temperature from about 30° C. to about 110° C. to form a silicone rubber latex, in the presence of a surfactant such as dodecylbenzenesulfonic acid. Alternatively, a cyclic siloxane such as cyclooctamethyltetrasiloxane and a tetraethoxyorthosilicate may be reacted with a first graft link monomer such as (gamma-methacryloxypropyl)methyldimethoxysilane, to afford silicone rubber having an average particle size from about 100 nanometers to about 2 micrometers. At least one branched acrylate rubber monomer is then polymerized with the silicone rubber particles, optionally in the presence of a cross linking monomer, such as allylmethacrylate in the presence of a free radical generating polymerization catalyst such as benzoyl peroxide. This latex is then reacted with a polymerizable alkenyl-containing organic material and a second graft link monomer. The latex particles of the graft silicone-acrylate rubber hybrid may be separated from the aqueous phase through coagulation (by treatment with a coagulant) and dried to a fine powder to produce the silicone-acrylate rubber impact modifier composition. This method can be generally used for producing the silicone-acrylate impact modifier having a particle size from about 100 nanometers to about two micrometers.

Processes known for the formation of the foregoing elastomer-modified graft copolymers include mass, emulsion, suspension, and solution processes, or combined processes such as bulk-suspension, emulsion-bulk, bulk-solution or other techniques, using continuous, semibatch, or batch processes.

If desired, the foregoing types of impact modifiers may be prepared by an emulsion polymerization process that is free of basic materials such as alkali metal salts of C₆₋₃₀ fatty acids, for example sodium stearate, lithium stearate, sodium oleate, potassium oleate, and the like, alkali metal carbonates, amines such as dodecyl dimethyl amine, dodecyl amine, and the like, and ammonium salts of amines, or any other material, such as an acid, that contains a degradation catalyst. Such materials are commonly used as surfactants in emulsion polymerization, and may catalyze transesterification and/or degradation of polycarbonates. Instead, ionic sulfate, sulfonate or phosphate surfactants may be used in preparing the impact modifiers, particularly the elastomeric substrate portion of the impact modifiers. Suitable surfactants include, for example, C₁₋₂₂ alkyl or C₇₋₂₅ alkylaryl sulfonates, C₁₋₂₂ alkyl or C₇₋₂₅ alkylaryl sulfates, C₁₋₂₂ alkyl or C₇₋₂₅ alkylaryl phosphates, substituted silicates, and mixtures thereof. A specific surfactant is a C₆₋₁₆, specifically a C₈₋₁₂ alkyl sulfonate. This emulsion polymerization process is described and disclosed in various patents and literature of such companies as Rohm & Haas and SABIC Innovative Plastics (formerly General Electric Company). In the practice, any of the above-described impact modifiers may be used providing it is free of the alkali metal salts of fatty acids, alkali metal carbonates and other basic materials.

A specific impact modifier of this type is a methyl methacrylate-butadiene-styrene (MBS) impact modifier wherein the butadiene substrate is prepared using above-described sulfonates, sulfates, or phosphates as surfactants. Other exemplary elastomer-modified graft copolymers include acrylonitrile-butadiene-styrene (ABS), acrylonitrile-styrene-butyl acrylate (ASA), methyl methacrylate-acrylonitrile-butadiene-styrene (MABS), and acrylonitrile-ethylene-propylene-diene-styrene (AES).

In some embodiments, the impact modifier is a graft polymer having a high rubber content, i.e., greater than or equal to about 50 wt %, optionally greater than or equal to about 60 wt % by weight of the graft polymer. The rubber is desirably present in an amount less than or equal to about 95 wt %, optionally less than or equal to about 90 wt % of the graft polymer.

The rubber forms the backbone of the graft polymer, and is desirably a polymer of a conjugated diene of formula (15) wherein each X^{b} and X^{c} is independently hydrogen, C₁-C₅ alkyl, chlorine, or bromine. Examples of dienes that may be used are butadiene, isoprene, 1,3-hepta-diene, methyl-1,3-pentadiene, 2,3-dimethyl-1,3-butadiene, 2-ethyl-1,3-pentadiene; 1,3- and 2,4-hexadienes, chloro and bromo substituted butadienes such as dichlorobutadiene, bromobutadiene, dibromobutadiene, mixtures comprising at least one of the foregoing dienes, and the like. A desired conjugated diene is butadiene. Copolymers of conjugated dienes with other monomers may also be used, for example copolymers of butadiene-styrene, butadiene-acrylonitrile, and the like. Alternatively, the backbone may be an acrylate rubber, such as one based on n-butyl acrylate, ethylacrylate, 2-ethylhexylacrylate, mixtures comprising at least one of the foregoing, and the like. Additionally, minor amounts of a diene may be copolymerized in the acrylate rubber backbone to yield improved grafting.

After formation of the backbone polymer, a grafting monomer is polymerized in the presence of the backbone polymer. One desired type of grafting monomer is a monovinylaromatic hydrocarbon of formula (16) wherein X^{e} and X^{f} are independently hydrogen, C₁-C₅ alkyl, or the like; and X^{d} is hydrogen, C₁-C₁₀ alkyl, C₁-C₁₀ cycloalkyl, C₁-C₁₀ alkoxy, C₆-C₁₈ alkyl, C₆-C₁₈ aralkyl, C₆-C₁₈ aryloxy, chlorine, bromine, and the like. Examples include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, mixtures comprising at least one of the foregoing compounds, and the like.

A second type of grafting monomer that may be polymerized in the presence of the polymer backbone are acrylic monomers of formula (17) wherein X^{g} and X^{h} are independently hydrogen, C₁-C₅ alkyl, or the like; and R is cyano, C₁-C₁₂ alkoxycarbonyl, or the like. Examples of such acrylic monomers include acrylonitrile, ethacrylonitrile, methacrylonitrile, alpha-chloroacrylonitrile, beta-chloroacrylonitrile, alpha-bromoacrylonitrile, beta-bromoacrylonitrile, methyl acrylate, methyl methacrylate, ethyl acrylate, butyl acrylate, propyl acrylate, isopropyl acrylate, mixtures comprising at least one of the foregoing monomers, and the like.

A mixture of grafting monomers may also be used, to provide a graft copolymer. An example of a suitable mixture comprises a monovinylaromatic hydrocarbon and an acrylic monomer. Examples of graft copolymers suitable for use include, but are not limited to, acrylonitrile-butadiene-styrene (ABS) and methacrylonitrile-butadiene-styrene (MBS) resins. Suitable high-rubber acrylonitrile-butadiene-styrene resins are available from SABIC Innovative Plastics (formerly General Electric Company) as BLENDEX® grades 131, 336, 338, 360, and 415.

In specific embodiments, the impact modifier (B) is selected from the group consisting of acrylonitrile-butadiene-styrene (ABS) polymers and methacrylonitrile-butadiene-styrene (MBS) polymers.

The polymer composition further comprises a non-glass filler (C). As used herein, the term “non-glass filler” includes any synthetic or naturally occurring reinforcing agents for polycarbonates and polycarbonate blends that produces balanced physical properties, does not degrade the polycarbonate or polycarbonate blend, and is not glass. Exemplary non-glass fillers include silicates and silica powders such as aluminum silicate (mullite), synthetic calcium silicate, zirconium silicate, fused silica, crystalline silica graphite, natural silica sand, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; kaolin, including hard kaolin, soft kaolin, calcined kaolin, kaolin comprising various coatings known in the art to facilitate compatibility with the polymeric matrix resin, or the like; mica, clay, carbon black, or the like, or combinations comprising at least one of the foregoing fillers.

In further specific embodiments, the non-glass filler is a mineral filler. Exemplary mineral fillers include calcium carbonates, such as chalk, limestone, marble, synthetic precipitated calcium carbonates, or the like; talc, including fibrous, modular, needle shaped, lamellar talc, or the like; wollastonite; surface-treated wollastonite; kaolin, including hard kaolin, soft kaolin, calcined kaolin, kaolin comprising various coatings known in the art to facilitate compatibility with the polymeric matrix resin, or the like; mica, clay, carbon black, or the like, or combinations thereof. The filler may be surface treated with silanes to improve adhesion and dispersion with the polymeric matrix resin.

The composition, when including a mineral filler, may include an acid or an acid salt. In one embodiment, the acid or acid salt is an inorganic acid or inorganic acid salt. In one embodiment, the acid is an acid comprising a phosphorous containing oxy-acid. In one embodiment, the phosphorous containing oxy-acid is a multi-protic phosphorus containing oxy-acid having the general formula (18):

HₘPₜOₙ (18)

where m and n are each 2 or greater and t is 1 or greater. Examples of the acids of formula (18) include, but are not limited to, acids represented by the following formulas: H₃PO₄, H₃PO₃, and H₃PO₂. Other exemplary acids include phosphoric acid, phosphorous acid, hypophosphorous acid, hypophosphoric acid, phosphinic acid, phosphonic acid, metaphosphoric acid, hexametaphosphoric acid, thiophosphoric acid, fluorophosphoric acid, difluorophosphoric acid, fluorophosphorous acid, difluorophosphorous acid, fluorohypophosphorous acid, or fluorohypophosphoric acid. Alternatively, acids and acid salts, such as, for example, sulphuric acid, sulphites, mono zinc phosphate, mono calcium phosphate, sodium acid pyrophosphate, mono natrium phosphate, and the like, may be used. The acid or acid salt is preferably selected so that it can be effectively combined with the mineral filler to produce a synergistic effect and a balance of properties, such as flow and impact, in the polycarbonate or polycarbonate blend.

In specific embodiments, the mineral filler (C) is talc. Generally, the talc can be of any shape, including fibrous, modular, needle shaped, or lamellar. If desired, the talc may be surface treated with silanes to improve adhesion and dispersion with the polymeric matrix resin. Acid may also be included with the talc. In such embodiments, the weight ratio of acid to talc, or acid:talc weight ratio, may be from about 0.02 to about 0.04.

The polymer composition further comprises an alicyclic hydrocarbon resin (D). Without being limited by theory, it appears the alicyclic hydrocarbon resin works not only as a flow promoter, but also a compatibilizer between the filler and the other resins of the composition, which provides a balance of physical properties. Particularly useful are low molecular weight hydrocarbon resins derived from unsaturated C₅ to C₉ monomers. Non-limiting examples include cyclic olefins and diolefins, e.g. cyclopentene, cyclopentadiene, cyclohexene, cyclohexadiene, methyl cyclopentadiene and the like; and cyclic diolefin dienes, e.g., dicyclopentadiene, methylcyclopentadiene dimer and the like. The resins can additionally be partially or fully hydrogenated. Exemplary commercial low molecular weight hydrocarbon resins may include the following: hydrocarbon resins available from Eastman Chemical under the trademark Piccotac®; the fully hydrogenated alicyclic hydrocarbon resin based on C₉ monomers available from Arakawa Chemical Inc. under the trademark Arkon® and sold, depending on softening point, as Arkon® P140, P125, P115, P100, P90, P70 or the partially hydrogenated hydrocarbon resins sold as Arkon® M135, M115, M100 and M90; the fully or partially hydrogenated hydrocarbon resin available from Eastman Chemical under the tradename Regalite® and sold, depending on softening point, as Regalite® R1100, S1100, R1125, R1090 and R010, or the partially hydrogenated resins sold as Regalite® R7100, R9100, S5100 and S7125; the hydrocarbon resins available from Exxon Chemical under the trade Escorez®, sold as the Escorez® 1000, 2000 and 5000 series, based on C₅, C₉ feedstock and mixes thereof, or the hydrocarbon resins sold as the Escorez® 5300, 5400 and 5600 series based on cyclic and C₉ monomers, optionally hydrogenated.

In particular embodiments, alicyclic saturated hydrocarbon resins are used. Such resins are available under the trade name Arkon™, available from Arakawa Chemical Industries, Ltd. The resin may have a number average molecular weight of about 1150. It can be odorless and colorless, have good weather resistance, and good compatibility with block rubber.

The resulting polymer compositions have a combination of desired properties, including improved tensile modulus, low temperature impact performance, and viscosity (i.e. flow). In specific embodiments, the polymer composition has (i) a melt viscosity of 420 Pa·sec or less when measured at 260° C. and 1500 sec⁻¹ and (ii) a notched Izod impact strength of about 200 J/m or greater when measured at 23° C. according to ASTM D256.

In further specific embodiments, the polymer composition has a melt viscosity of 420 Pa·sec or less when measured at 260° C. and 1500 sec⁻¹; a melt viscosity of 300 Pa·sec or less when measured at 260° C. and 1500 sec⁻¹; a tensile modulus of from about 2600 MPa to about 4800 MPa according to ASTM D638; a tensile modulus of from about 3000 MPa to about 3800 MPa according to ASTM D638; or a notched Izod impact strength of about 400 J/m or greater when measured at 23° C. according to ASTM D256.

In embodiments, the polymer composition comprises from about 40 to about 70 weight percent of polycarbonate polymer (A); from about 2 to about 12 weight percent of impact modifier (B); from about 5 to about 20 weight percent of non-glass filler (C); and/or less than about 10 weight percent of alicyclic hydrocarbon resin (D). In more specific embodiments, the polymer composition comprises from about 4 to about 10 weight percent of impact modifier (B); from about 6 to about 15 weight percent of non-glass filler (C); less than about 8 weight percent of alicyclic hydrocarbon resin (D); or from about 2 to about 8 weight percent of alicyclic hydrocarbon resin (D).

In some additional embodiments, the polymer composition further comprises a polycarbonate-polysiloxane copolymer (E). When the polycarbonate-polysiloxane copolymer is present, it comprises less than about 20 weight percent of the composition. In further embodiments, the polycarbonate-polysiloxane copolymer comprises less than about 15 weight percent of the composition, from about 6 to about 15 weight percent of the composition, or from about 6 to about 12 weight percent of the composition.

In other additional embodiments, the polymer composition further comprises either (i) an acrylate polymer (F) or (ii) an organic phosphate (G) selected from the group consisting of bisphenol-A bis(diphenylphosphate), resorcinol bis(diphenylphosphate), and triphenyl phosphate. Without being limited by theory, it appears that although the organic phosphates (G) are typically considered as flame retardants, these three organic phosphates are liquids with low molecular weight and good compatibility with polycarbonates. As a result, their use allows for a better balance of physical properties. In embodiments, the polymer composition further comprising either (i) an acrylate polymer or (ii) the organic phosphates described above has (a) a melt viscosity of 420 Pa·sec or less when measured at 260° C. and 1500 sec¹; (b) a tensile modulus of from about 2600 MPa to about 4800 MPa according to ASTM D638; and (c) a notched Izod impact strength of about 400 J/m or greater when measured at 23° C. according to ASTM D256. They may also have the narrower properties described above.

The acrylate polymer (F) may be prepared from acrylate monomers having the general formula (19):

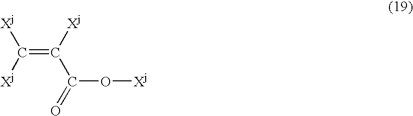

wherein each X^{j} is independently selected from hydrogen, C₁₋₁₈ alkyl, C₆₋₂₀ aromatic, C₁₋₁₈ substituted alkyl, and C₆₋₂₀ substituted aromatic, Exemplary acrylate monomers include acrylic acid, methyl methacrylate, ethyl methacrylate, n-butyl methacrylate, t-butyl methacrylate, n-propyl methacrylate, isopropyl methacrylate, 2-ethylhexyl methacrylate, n-butyl acrylate, t-butyl acrylate, n-propyl acrylate, isopropyl acrylate, 2-ethylhexyl acrylate, and the like, and combinations comprising at least one of the foregoing monomers.

In some embodiments, the polymer composition further comprises an acrylate polymer (F) and an organic phosphate (G) selected from the group consisting of bisphenol-A bis(diphenylphosphate), resorcinol bis(diphenylphosphate), and triphenyl phosphate. It was unexpectedly found that the combination of an alicyclic hydrocarbon resin with an acrylate polymer and an organic phosphate produced a synergistic balance of physical properties.

In embodiments where the acrylate polymer (F) and organic phosphate (G) are present, the acrylate polymer and organic phosphate together comprise from about 3 to about 20 weight percent of the composition. The acrylate polymer should be less than about 15 weight percent of the composition. The organic phosphate is generally present in the amount of from about 2 to 4 weight percent. The weight ratio of acrylate polymer to alicyclic hydrocarbon resin may be from about 1:10 to about 10:1, or from about 1:4 to about 4:1. The weight ratio of organic phosphate to alicyclic hydrocarbon resin may also be from about 1:10 to about 10:1, or from about 1:4 to about 4:1. The weight ratio of acrylate polymer to organic phosphate will vary depending on their amount in the polymer composition. For example, when they comprise from about 3 to about 10 weight percent of the composition, the ratio may be about 1:1 or greater, but when they comprise from about 10 to about 20 weight percent of the composition, the ratio should be greater than about 3:1.

In embodiments, a polymer composition comprising both the acrylate polymer and organic phosphate has (a) a melt viscosity of 300 Pa·sec or less when measured at 260° C. and 1500 sec⁻¹; (b) a tensile modulus of from about 3000 MPa to about 3800 MPa according to ASTM D638; and (c) a notched Izod impact strength of about 400 J/m or greater when measured at 23° C. according to ASTM D256.

For melt viscosity, a higher value indicates that the composition is thicker, i.e. flows less easily. A lower value is generally desired for melt viscosity. For tensile modulus, a higher value indicates better impact strength. Similarly, a higher notched Izod impact strength indicates better impact strength.

The thermoplastic composition may also include various additives, with the proviso that the additives do not adversely affect the desired properties of the thermoplastic compositions. Mixtures of additives may be used. Such additives may be mixed at a suitable time during the mixing of the components for forming the composition.

The thermoplastic composition may comprise a primary antioxidant or “stabilizer” (e.g., a hindered phenol and/or secondary aryl amine) and, optionally, a secondary antioxidant (e.g., a phosphate and/or thioester). Suitable antioxidant additives include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants are generally used in amounts of about 0.01 to about 1 parts by weight, optionally about 0.05 to about 0.5 parts by weight, based on 100 parts by weight of the composition components (A), (B), (C) and (D).

Suitable heat stabilizer additives include, for example, organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations comprising at least one of the foregoing heat stabilizers. Heat stabilizers are generally used in amounts of about 0.01 to about 5 parts by weight, optionally about 0.05 to about 0.3 parts by weight, based on 100 parts by weight of the composition components (A), (B), (C) and (D).

Light stabilizers and/or ultraviolet light (UV) absorbing additives may also be used. Suitable light stabilizer additives include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers. Light stabilizers are generally used in amounts of about 0.01 to about 10 parts by weight, optionally about 0.1 to about 1 parts by weight, based on 100 parts by weight of the composition components (A), (B), (C) and (D).

Suitable UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™5411); 2-hydroxy-4-n-octyloxybenzophenone (CYASORB™531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenylacryloyl)oxy]methyl]propane (UVINUL™ 3030); 2,2′-(1,4-phenylene) bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than about 100 nanometers; or the like, or combinations comprising at least one of the foregoing UV absorbers. UV absorbers are generally used in amounts of about 0.1 to about 5 parts by weight, based on 100 parts by weight of the composition components (A), (B), (C) and (D).

Plasticizers, lubricants, and/or mold release agents additives may also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like. Such materials are generally used in amounts of about 0.1 to about 20 parts by weight, optionally about 1 to about 10 parts by weight, based on 100 parts by weight of the composition components (A), (B), (C) and (D).

The term “antistatic agent” refers to monomeric, oligomeric, or polymeric materials that can be processed into polymer resins and/or sprayed onto materials or articles to improve conductive properties and overall physical performance. Examples of monomeric antistatic agents include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents include certain polyesteramides, polyether-polyamide (polyetheramide) block copolymers, polyetheresteramide block copolymers, polyetheresters, or polyurethanes, each containing polyalkylene glycol moieties such as polyethylene glycol, polypropylene glycol, polytetramethylene glycol, and the like. Such polymeric antistatic agents are commercially available, such as, for example, Pelestat™ 6321 (Sanyo), Pebax™ MH1657 (Atofina), and lrgastat™ P18 and P22 (Ciba-Geigy). Other polymeric materials that may be used as antistatic agents are inherently conducting polymers such as polyaniline (commercially available as PANIPOL®EB from Panipol), polypyrrole and polythiophene (commercially available from Bayer), which retain some of their intrinsic conductivity after melt processing at elevated temperatures. In one embodiment, carbon fibers, carbon nanofibers, carbon nanotubes, carbon black, or any combination of the foregoing may be used in a polymeric resin containing chemical antistatic agents to render the composition electrostatically dissipative. Antistatic agents are generally used in amounts of about 0.1 to about 10 parts by weight, based on 100 parts by weight of the composition components (A), (B), (C) and (D).

Colorants such as pigment and/or dye additives may also be present. Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates sulfates, chromates, or the like; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations comprising at least one of the foregoing pigments. Pigments are generally used in amounts of about 0.01 to about 10 parts by weight, based on 100 parts by weight of the composition components (A), (B), (C) and (D).

Suitable dyes are generally organic materials and include, for example, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-d icyanomethylene-2-methyl-6-(p-dimethylaminostyryl)-4H-pyran; 1,1′-d iethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene; chrysene; rubrene; coronene, or the like, or combinations comprising at least one of the foregoing dyes. Dyes are generally used in amounts of about 0.1 to about 10 ppm, based on 100 parts by weight of the composition components (A), (B), (C) and (D).

If desired, a flame retardant additive may be added to the composition. Suitable flame retardants that may be added may be organic compounds that include phosphorus, bromine, and/or chlorine. Non-brominated and non-chlorinated phosphorus-containing flame retardants may be desired in certain applications for regulatory reasons, for example organic phosphates and organic compounds containing phosphorus-nitrogen bonds.

Halogenated materials may also be used as flame retardants, for example halogenated compounds and resins of formula (20):

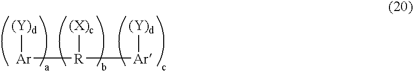

wherein R is an alkylene, alkylidene or cycloaliphatic linkage, e.g., methylene, ethylene, propylene, isopropylene, isopropylidene, butylene, isobutylene, amylene, cyclohexylene, cyclopentylidene, or the like; or an oxygen ether, carbonyl, amine, or a sulfur containing linkage, e.g., sulfide, sulfoxide, sulfone, or the like. R can also consist of two or more alkylene or alkylidene linkages connected by such groups as aromatic, amino, ether, carbonyl, sulfide, sulfoxide, sulfone, or the like. Ar and Ar′ in formula (19) are each independently mono- or polycarbocyclic aromatic groups such as phenylene, biphenylene, terphenylene, naphthylene, or the like.

Y is an organic, inorganic, or organometallic radical, for example (1) halogen, e.g., chlorine, bromine, iodine, fluorine or (2) ether groups of the general formula OE, wherein E is a monovalent hydrocarbon radical similar to X or (3) monovalent hydrocarbon groups of the type represented by R or (4) other substituents, e.g., nitro, cyano, and the like, said substituents being essentially inert provided that there is at least one and optionally two halogen atoms per aryl nucleus.

When present, each X is independently a monovalent hydrocarbon group, for example an alkyl group such as methyl, ethyl, propyl, isopropyl, butyl, decyl, or the like; an aryl groups such as phenyl, naphthyl, biphenyl, xylyl, tolyl, or the like; and aralkyl group such as benzyl, ethylphenyl, or the like; a cycloaliphatic group such as cyclopentyl, cyclohexyl, or the like. The monovalent hydrocarbon group may itself contain inert substituents.

Each d is independently 1 to a maximum equivalent to the number of replaceable hydrogens substituted on the aromatic rings comprising Ar or Ar′. Each e is independently 0 to a maximum equivalent to the number of replaceable hydrogens on R. Each a, b, and c is independently a whole number, including 0. When b is not 0, neither a nor c may be 0. Otherwise either a or c, but not both, may be 0. Where b is 0, the aromatic groups are joined by a direct carbon-carbon bond.

The hydroxyl and Y substituents on the aromatic groups, Ar and Ar′ can be varied in the ortho, meta or para positions on the aromatic rings and the groups can be in any possible geometric relationship with respect to one another.

Included within the scope of the above formula are bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; and 2,2-bis-(3,5-dichloro-4-hydroxyphenyl)-propane 2,2bis-(3-bromo-4-hydroxyphenyl)-propane. Also included within the above structural formula are: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

Also useful are oligomeric and polymeric halogenated aromatic compounds, such as a copolycarbonate of bisphenol A and tetrabromobisphenol A and a carbonate precursor, e.g., phosgene. Metal synergists, e.g., antimony oxide, may also be used with the flame retardant.

Inorganic flame retardants may also be used, for example salts of C₁₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate, and the like; salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or a fluoro-anion complex such as Li₃AlF₆, BaSiF₆, KBF₄, K₃AlF₆, KAlF₄, K₂SiF₆, and/or Na₃AlF₆ or the like.

Generally, a loading of 6 to 12 weight percent is needed for effective flame retardance. In embodiments including an organic phosphate (G) selected from the group consisting of bisphenol-A bis(diphenylphosphate), resorcinol bis(diphenylphosphate), and triphenyl phosphate, the organic phosphate (G) should not be considered a flame retardant because it is generally present in loadings too low to be effective for flame retardance.

Anti-drip agents may also be used, for example a fibril forming or non-fibril forming fluoropolymer such as polytetrafluoroethylene (PTFE). The anti-drip agent may be encapsulated by a rigid copolymer as described above, for example SAN. PTFE encapsulated in SAN is known as TSAN. Encapsulated fluoropolymers may be made by polymerizing the encapsulating polymer in the presence of the fluoropolymer, for example, in an aqueous dispersion. TSAN may provide significant advantages over PTFE, in that TSAN may be more readily dispersed in the composition. A suitable TSAN may comprise, for example, about 50 wt % PTFE and about 50 wt % SAN, based on the total weight of the encapsulated fluoropolymer. The SAN may comprise, for example, about 75 wt % styrene and about 25 wt % acrylonitrile based on the total weight of the copolymer. Alternatively, the fluoropolymer may be pre-blended in some manner with a second polymer, such as for, example, an aromatic polycarbonate resin or SAN to form an agglomerated material for use as an anti-drip agent. Either method may be used to produce an encapsulated fluoropolymer.

Where a foam is desired, suitable blowing agents include, for example, low boiling halohydrocarbons and those that generate carbon dioxide; blowing agents that are solid at room temperature and when heated to temperatures higher than their decomposition temperature, generate gases such as nitrogen, carbon dioxide or ammonia gas, such as azodicarbonamide, metal salts of azodicarbonamide, 4,4′ oxybis(benzenesulfonylhydrazide), sodium bicarbonate, ammonium carbonate, or the like; or combinations comprising at least one of the foregoing blowing agents.

The thermoplastic compositions may be manufactured by methods generally available in the art. For example, in one embodiment, in one manner of proceeding, the composition components (A), (B), (C) and (D) and any other optional components (such as antioxidants, mold release agents, and the like) are first blended, in a Henschel™ high speed mixer or other suitable mixer/blender. Other low shear processes including but not limited to hand mixing may also accomplish this blending. The blend is then fed into the throat of a twin-screw extruder via a hopper. Alternatively, one or more of the components may be incorporated into the composition by feeding directly into the extruder at the throat and/or downstream through a sidestuffer. Such additives may also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate may be one-fourth inch long or less as desired. Such pellets may be used for subsequent molding, shaping, or forming.

The increased heat resistance of the thermoplastic compositions allows the compositions to be used in high heat products and industrial applications such as painting and in high temperature environments.

Shaped, formed, or molded articles comprising the polycarbonate compositions are also provided. The polycarbonate compositions may be molded into useful shaped articles by a variety of means such as injection molding, extrusion, rotational molding, blow molding and thermoforming to form articles such as, for example, computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, electronic device casings and signs and the like. In addition, the polycarbonate compositions may be used for such applications as automotive panel and trim. Examples of suitable articles are exemplified by but are not limited to aircraft, automotive, truck, military vehicle (including automotive, aircraft, and water-borne vehicles), scooter, and motorcycle exterior and interior components, including panels, quarter panels, rocker panels, trim, fenders, doors, deck-lids, trunk lids, hoods, bonnets, roofs, bumpers, fascia, grilles, mirror housings, pillar appliqués, cladding, body side moldings, wheel covers, hubcaps, door handles, spoilers, window frames, headlamp bezels, headlamps, tail lamps, tail lamp housings, tail lamp bezels, license plate enclosures, roof racks, and running boards; enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings; personal water-craft; jet-skis; pools; spas; hot tubs; steps; step coverings; building and construction applications such as glazing, roofs, windows, floors, decorative window furnishings or treatments; treated glass covers for pictures, paintings, posters, and like display items; wall panels, and doors; counter tops; protected graphics; outdoor and indoor signs; enclosures, housings, panels, and parts for automatic teller machines (ATM); computer; desk-top computer; portable computer; lap-top computer; hand held computer housings; monitor; printer; keyboards; FAX machine; copier; telephone; phone bezels; mobile phone; radio sender; radio receiver; enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; shoe laces; articles made from plastic-wood combinations; golf course markers; utility pit covers; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated painted articles; coated dyed articles; coated fluorescent articles; coated foam articles; and like applications. The invention further contemplates additional fabrication operations on said articles, such as, but not limited to, molding, in-mold decoration, baking in a paint oven, lamination, and/or thermoforming. The articles made from the composition of the present invention may be used widely in automotive industry, home appliances, electrical components, and telecommunications.

The following examples are provided to illustrate the polycarbonate compositions, articles, and methods of the present disclosure. The examples are merely illustrative and are not intended to limit the disclosure to the materials, conditions, or process parameters set forth therein.

### EXAMPLES

Mechanical properties were measured according to the following ASTM or ISO standards, as indicated:

| | Standards | Testing Conditions |
|---|---|---|
| Tensile Modulus | ASTM D638 | 5 mm/min, 25° C. |
| Notched Izod Impact Strength | ASTM D256 | Various temp |
| Melt Viscosity | ISO 11443 | 260° C. (280° C. |
| | | where noted), 1500 sec⁻¹ |
| Heat Deflection Temperature | ASTM D648 | 1.8 MPa, flat |
| | | 3.2 mm thick bar |
| Flexural Modulus | ASTM D790 | 1.3 mm/min, |
| | | 50 mm span |
| Melt Flow Rate (MFR) | ASTM D1238 | 260° C., 5 kg |

It was also noted the ductility (%) in the Notched Izod impact tests whether the failure mode was brittle or ductile in nature. Brittle failure meant that the molded bar completely broke into unconnected pieces in the test, and ductile failure meant that the pieces of the molded bar remained connected after the test.

The Examples discussed herein used the following ingredients in their compositions:

| Ingredient | Description | Supplier |
|---|---|---|
| PC-1 | High flow BPA polycarbonate polymer resin made by the interfacial | SABIC Innovative |
| | process with a Mw of about 21,700 Daltons versus polycarbonate | Plastics |
| | standards | |
| PC-2 | Low flow BPA polycarbonate polymer resin made by the interfacial | SABIC Innovative |
| | process with a Mw of about 29,600 Daltons versus polycarbonate | Plastics |
| | standards; PC split = 10% | |
| PC-Si | a BPA polycarbonate-polysiloxane copolymer comprising about 20% | SABIC Innovative |
| | by weight of siloxane, 80% by weight BPA, PCP encapped | Plastics |
| talc | fine talc (magnesium silicate hydrate), (Grade Jetfine 3CA) | Luzenac Europe |
| PMMA | Methyl methacrylate (MMA)-ethyl acrylate (EA) co-polymer, comprising | Atohaas Elf |
| | about 99.5 wt % MMA and about 0.5 wt % EA | Atochem Italia |
| | | Co. |
| FP | Flow promoter (Low molecular weight hydrocarbon resin made from | Arakawa |
| | C₅-C₉ petroleum feedstock); Mn = 1150 (Arkon P-125)-- | Chemical |
| | Poly(methylstyrene-co-indene), hydrogenated, CAS No 69430-35-9 | Industries, Ltd. |
| BPADP | bisphenol-A bis(diphenylphosphate) | Asahidenka |
| SAN | styrene-acrylonitrile copolymer with nominal 26-28% acrylonitrile | SABIC Innovative |
| | content, Mw of about 170,000 (calibrated on polystyrene standards | Plastics |
| | based on GPC) | |
| HRG | high rubber graft emulsion polymerized ABS comprising 9.6-12.6 wt % | SABIC Innovative |
| | acrylonitrile and 37-40 wt % styrene grafted to 49-51 wt % | Plastics |
| | polybutadiene with a crosslink density of 43-55% | |
| quencher | H₃PO₃, 50% in water | |
| MBS | Methylmethacrylate-butadiene-styrene copolymer powder, trade name | Rohm & Haas |
| | EXL2691A | |
| Terpolymer | siloxane-butyl acrylate-methyl methacrylate terpolymer, tradename | Mitsubishi Rayon |
| | S2001 | Co, Ltd. |

The Examples discussed herein were prepared by melt extrusion on a Toshiba twin screw extruder using a nominal melt temperature of 270° C. and 350 rpm. The extrudate was pelletized and dried at about 100° C. for about 3 hours. To make test specimens, the dried pellets were injection molded using a Fanuc injection-molding machine at 260° C. to form specimens for obtaining heat deflection temperature, Izod impact, tensile modulus, and flexural modulus data.

### Example 1

Eleven example compositions E1-E11 were made along with four control compositions C₁-C₄. Generally, they varied in the presence and amount of Flow Promoter (FP), BPADP, and PMMA. The compositions and results are shown below in Tables 1 and 2. The amount of each ingredient is given in weight percent.

TABLE 1

| Description | Unit | C1 | C2 | C3 | C4 | E1 | E2 | E3 | E4 | E5 | E6 | E7 |
|---|---|---|---|---|---|---|---|---|---|---|---|---|
| PC-1 | % | 51 | 60 | 55 | 49.6 | 46 | 46.7 | 48 | 43 | 45 | 44.7 | 42 |
| PC-2 | % | 22 | 27 | 25 | 22.4 | 21 | 21.3 | 22 | 20 | 21 | 20.3 | 19 |
| PC-Si | % | 0 | 0 | 0 | 8 | 8 | 8 | 8 | 8 | 8 | 8 | 8 |
| HRG | % | 13 | 13 | 8 | 8 | 8 | 8 | 8 | 8 | 8 | 8 | 8 |
| Talc | % | | 0 | 12 | 12 | 12 | 12 | 12 | 12 | 12 | 12 | 12 |
| PMMA | % | | | | | 5 | | | 5 | | 5 | 5 |
| FP | % | | | | | | 4 | | 4 | 4 | | 4 |
| BPADP | % | | | | | | | 2 | | 2 | 2 | 2 |
| SAN | % | 13 | | | | | | | | | | |
| Melt | Pa · s | 269.8 | 426.5 | 423.8 | 416.4 | 410.2 | 351.0 | 388.0 | 365.0 | 321.1 | 365.7 | 299.0 |
| Viscosity | | | | | | | | | | | | |
| Ductility | % | 100 | 100 | 100 | 100 | 100 | 100 | 100 | 100 | 100 | 100 | 100 |
| @23° C. | | | | | | | | | | | | |
| Impact | J/m | 680 | 686 | 651 | 781 | 732 | 757 | 659 | 688 | 699 | 587 | 614 |
| Strength | | | | | | | | | | | | |
| @23° C. | | | | | | | | | | | | |
| Ductility | % | 60 | 100 | 0 | 0 | 0 | 0 | 0 | 0 | 0 | 0 | 0 |
| @−30° C. | | | | | | | | | | | | |
| Impact | J/m | 257 | 612 | 113 | 203 | 149 | 199 | 146 | 107 | 143 | 95.9 | 86.9 |
| Strength | | | | | | | | | | | | |
| @−30° C. | | | | | | | | | | | | |
| Tensile | GPa | 2.3 | 2.1 | 3.4 | 3.3 | 3.3 | 3.2 | 3.6 | 3.3 | 3.5 | 3.7 | 3.6 |
| Modulus | | | | | | | | | | | | |
| Flexural | GPa | 2.4 | 1.9 | 3.1 | 3.0 | 3.0 | 2.9 | 3.2 | 3.0 | 3.2 | 3.3 | 3.2 |
| Modulus | | | | | | | | | | | | |
| HDT | ° C. | 116 | 118 | 123 | 122 | 119 | 119 | 116 | 116 | 113 | 112 | 110 |

In Table 1, comparing C₂-C₄, the addition of filler caused the tensile modulus to improve. Table 1 also shows the synergistic effect of using both an acrylate polymer and an organic phosphate to the alicyclic hydrocarbon resin. E1, E2, and E3 show the results of adding each component (PMMA, FP, and BPADP) separately to C4. In particular, the addition of Flow Promoter (FP) (E2) decreased the melt viscosity by 16%, while the impact strength, tensile modulus and HDT changed very slightly (2-3%).

E4, E5 and E6 showed the results of adding combinations of two components (PMMA, FP, and BPADP) to C4. All three had improved flow (lower viscosity) compared to C4. They also maintained acceptable notched Izod impact strength and tensile modulus values, for a good balance of physical properties. For example, in E4, the melt viscosity did not decrease as much as expected and the notched Izod impact strengths at both 23° C. and −30° C. decreased more than expected. In E5, the melt viscosity decreased as expected, but the tensile modulus did not increase as expected. In E6, the notched Izod impact strengths at both 23° C. and −30° C. decreased more than expected and the tensile modulus did not increase as expected.

E7 showed the results of adding all three components to C4. Improvements in the melt viscosity and tensile modulus were synergistic. In E7, the melt viscosity decreased 20% more than expected from the results of E1-E3. The tensile modulus also increased 10% more than expected. The notched Izod impact strength at 23° C. decreased about as expected, while the impact strength at −30° C. decreased more than expected. However, this particular result is acceptable. A better balance of physical properties was thus achieved.

TABLE 2

| Description | Unit | C1 | E8 | E9 | E7 | E10 | E11 |
|---|---|---|---|---|---|---|---|
| PC-1 | % | 51 | 45 | 46.6 | 42 | 42 | 37 |
| PC-2 | % | 22 | 21 | 21.4 | 19 | 19 | 17 |
| PC-Si | % | | 8 | 8 | 8 | 8 | 8 |
| HRG | % | 13 | 8 | 8 | 8 | 8 | 8 |
| Talc | % | | 12 | 12 | 12 | 12 | 12 |
| PMMA | % | | | | 5 | 3.5 | 8 |
| FP | % | | 6 | | 4 | 5 | 6 |
| BPADP | % | | | 4 | 2 | 2.5 | 4 |
| SAN | % | 13 | | | | | |
| Melt Viscosity | Pa · s | 269.8 | 297.4 | 335.6 | 299.0 | 279.6 | 214.8 |
| Ductility @23° C. | % | 100 | 100 | 100 | 100 | 100 | 100 |
| Impact Strength | J/m | 680 | 705 | 553 | 614 | 612 | 424 |
| @23° C. | | | | | | | |
| Ductility @−30° C. | % | 60 | 0 | 0 | 0 | 0 | 0 |
| Impact Strength | J/m | 257 | 202 | 101 | 86.9 | 102 | 69 |
| @−30° C. | | | | | | | |
| Tensile Modulus | GPa | 2.3 | 3.2 | 3.7 | 3.6 | 3.6 | 3.8 |
| Flexural Modulus | GPa | 2.4 | 2.9 | 3.3 | 3.2 | 3.2 | 3.3 |
| HDT | ° C. | 116 | 118 | 110 | 110 | 108 | 100 |

Table 2 shows the effect of varying the amounts of and the ratios of the alicyclic hydrocarbon resin, acrylate polymer, and organic phosphate. Comparing E11, which used a greater total amount of the three components, to E7 and E10, E11 had decreased melt viscosity and increased tensile modulus, but significantly decreased impact strengths. Comparing E7 with E10, E10 had better melt viscosity, tensile modulus, and impact strength at −30° C.

### Example 2

Five example compositions E12-E16 were made along with one control composition C5. Generally, they varied in the amount of FP, BPADP, and PMMA. The compositions and results are shown below in Table 3. The amount of each ingredient is given in weight percent. In addition, E13, E15, E16, and C5 all contained white pigment (not listed).

Three of the compositions were also measured for molecular weight distribution and yellowness index before and after aging at 70° C., 95% relative humidity for 1000 hours. That data is also shown in Table 3.

TABLE 3

| Item Description | Unit | E12 | E13 | E14 | E15 | E16 | C5 |
|---|---|---|---|---|---|---|---|
| PC-1 | % | 47.54 | 47.54 | 52.5 | 52.5 | 45.3 | 51.55 |
| PC-2 | % | 15 | 15 | 12.54 | 12.54 | 15 | 22.13 |
| PC-Si | % | 8 | 8 | 8 | 8 | 8 | |
| Talc | % | 12 | 12 | 12 | 12 | 12 | |
| HRG | % | 8 | 8 | 8 | 8 | 8 | 12.97 |
| PMMA | % | 5 | 5 | | | 3.75 | |
| FP | % | 4 | 4 | 4.5 | 4.5 | 5 | |
| SAN | % | | | | | | 12.97 |
| BPADP | % | | | 2 | 2 | 2.5 | |
| Melt Viscosity | Pa · s | 347.8 | 354.5 | 310.4 | 364.4 | 281.0 | 269.8 |
| Impact Strength | J/m | 702 | 745 | 723 | 500 | 779 | 680 |
| @23° C. | | | | | | | |
| Impact Strength | J/m | 129 | 128 | 165 | 107 | 144 | 257 |
| @−30° C. | | | | | | | |
| Tensile Modulus | MPa | 3.3 | 3.3 | 3.3 | 3.5 | 3.5 | 2.3 |
| Flexural Modulus | MPa | 3.3 | — | 3.4 | — | 3.5 | 2.4 |

Before Aging

| | | | | | | | |
|---|---|---|---|---|---|---|---|
| Impact Strength | J/m | 702 | 745 | 723 | 500 | 779 | 680 |
| @23° C. | | | | | | | |
| Flexural Modulus | MPa | 3.3 | — | 3.4 | — | 3.5 | 2.4 |
| Mw-PC | Daltons | 47700 | | 46800 | | | 49100 |
| Mn-PC | Daltons | 16000 | | 15600 | | | 16700 |
| Yellowness Index | — | | 5.8 | | 5.8 | | 7.3 |

After Aging

| | | | | | | |
|---|---|---|---|---|---|---|
| Impact Strength | | 464 | | 461 | | 166 |
| @23° C. | | | | | | |
| Flexural Modulus | | 3.1 | | 3.2 | | 2.3 |
| Mw-PC | Daltons | 41990 | | 41300 | | 36500 |
| Mn-PC | Daltons | 14300 | | 14000 | | 12750 |
| Yellowness Index | — | | 8.0 | | 9.3 | 13.0 |

The Example compositions had improved tensile modulus and good impact strength and flow properties. E13 had better impact strength than E15, as well as better retention of properties after aging.

### Example 3

Four example compositions E17-E20 were made. Generally, they varied in the impact modifier used. The compositions and results are shown below in Table 4. The amount of each ingredient is given in weight percent.

TABLE 4

| Description | Unit | E17 | E18 | E19 | E20 |
|---|---|---|---|---|---|
| PC-1 | % | 51.7 | 57.83 | 61.61 | 47.54 |
| PC-2 | % | 22.1 | 19.3 | 15.4 | 15 |
| PC-Si | % | | | | 8 |
| HRG | % | 8.0 | | | 8 |
| MBS | % | | 4.4 | 4.4 | |
| SAN | % | 9.5 | 9.5 | 9.5 | |
| other | % | 0.75 | 0.85 | 0.85 | 0.46 |
| quencher | % | | 0.108 | 0.24 | 0 |
| PMMA | % | | | | 5 |
| FP | % | | | | 4 |
| talc | % | 8 | 8 | 8 | 12 |
| MFR | g/10 min | 12 | 12 | 11 | 15 |
| Tensile Modulus | GPa | 3.1 | 3.1 | 3.2 | 3.3 |
| Flexural Modulus | GPa | 3.0 | 3.0 | 3.1 | 3.4 |
| Impact Strength | J/m | 190 | 490 | 500 | 700 |
| @ 23° C. | | | | | |
| Impact Strength | J/m | 75 | 118 | 120 | 130 |
| @ −30° C. | | | | | |
| HDT | ° C. | 116 | 120 | 120 | 117 |

Generally, the addition of filler induces poorer flow properties (i.e. greater viscosity, lower melt flow rate) and poorer impact performance (i.e. lower impact strength). However, E20 has the highest MFR and the highest impact strength as well of the four example compositions, even though it has the highest loading of filler.

### Example 4

Two example compositions E21 and E22 were made, along with one control composition C6, to show the properties of compositions with high talc loadings. The compositions and results are shown below in Table 5. The amount of each ingredient is given in weight percent.

TABLE 5

| Item Description | Unit | E21 | E22 | C6 |
|---|---|---|---|---|
| PC-1 | % | 36.4 | 35 | 13.36 |
| PC-2 | % | 18 | 17 | 53.3 |
| PC-Si | % | 10 | 10 | |
| Talc | % | 18 | 18 | 18 |
| HRG | % | 8 | 8 | |
| MBS | | | | 4.4 |
| PMMA | % | 4 | 4 | |
| FP | % | 5 | 5 | |
| BPADP | % | | 2.5 | |
| SAN | | | | 9.5 |
| MFR | g/10 min | 12.7 | 16.6 | 8.1 |
| Melt Viscosity | Pa · s | 310.9 | 270.8 | 388.5 |
| Impact Strength | J/m | 455 | 314 | 259 |
| @23° C. | | | | |
| Impact Strength | J/m | 108 | 77 | 88 |
| @−30° C. | | | | |
| Tensile Modulus | GPa | 4.0 | 4.3 | 4.3 |
| Flexural Modulus | GPa | 3.5 | 3.7 | 3.7 |

The use of all three components in E22 provided a better blend of properties than just two components, as in E21. The drop in impact strength at 23° C. was compensated for by the improvement in melt viscosity and tensile modulus. Both E21 and E22 had a better balance of properties than C6.

The polymer compositions of the present disclosure have been described with reference to exemplary embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A polymer composition comprising:
a polycarbonate polymer;
an impact modifier;
a non-glass filler; and
an alicyclic hydrocarbon resin;
wherein the polymer composition has a melt viscosity of 420 Pa·sec or less when measured at 260° C. and 1500 sec⁻¹, and a notched Izod impact strength of about 200 J/m or greater when measured at 23° C. according to ASTM D256.

2. The polymer composition of claim 1, wherein the alicyclic hydrocarbon resin comprises 10 weight percent or less of the composition.

3. The polymer composition of claim 1, wherein the alicyclic hydrocarbon resin comprises from about 2 to about 8 weight percent of the composition.

4. The polymer composition of claim 1, wherein the filler comprises from about 5 to about 20 weight percent of the composition.

5. The polymer composition of claim 1, wherein the impact modifier comprises from about 2 to about 12 weight percent of the composition.

6. The polymer composition of claim 1, further comprising a polycarbonate-polysiloxane copolymer.

7. The polymer composition of claim 6, wherein the polycarbonate-polysiloxane copolymer comprises less than about 20 weight percent of the composition.

8. The polymer composition of claim 6, wherein the polycarbonate-polysiloxane copolymer comprises from about 6 to about 15 weight percent of the composition.

9. The polymer composition of claim 1, wherein the composition further comprises an acrylate polymer.

10. The polymer composition of claim 1, wherein the composition further comprises an organic phosphate selected from the group consisting of bisphenol-A bis(diphenylphosphate), resorcinol bis(diphenylphosphate), and triphenyl phosphate.

11. The polymer composition of claim 10, wherein the composition further comprises an acrylate polymer.

12. The polymer composition of claim 11, wherein the weight ratio of acrylate polymer to alicyclic hydrocarbon resin is from about 1:10 to about 10:1.

13. The polymer composition of claim 11, wherein the acrylate polymer and the organic phosphate together comprise from about 3 to about 20 weight percent of the composition.

14. The polymer composition of claim 1, wherein the impact modifier is selected from the group consisting of acrylonitrile-butadiene-styrene (ABS) polymers and methacrylate-butadiene-styrene (MBS) polymers.

15. The polymer composition of claim 1, wherein the polymer composition has a melt viscosity of 365 Pa·sec or less, when measured at 260° C. and 1500 sec⁻¹.

16. The polymer composition of claim 1, wherein the polymer composition has a tensile modulus of from about 2600 MPa to about 4800 MPa, according to ASTM D638.

17. The polymer composition of claim 1, wherein the polymer composition has a notched Izod impact strength of about 400 J/m or greater when measured at 23° C. according to ASTM D256.

18. The polymer composition of claim 1, wherein the filler is talc.

19. A polymer composition comprising:
a polycarbonate polymer;
an impact modifier;
a mineral filler;
an alicyclic hydrocarbon resin; and
either an acrylate polymer or an organic phosphate selected from the group consisting of bisphenol-A bis(diphenylphosphate), resorcinol bis(diphenylphosphate), and triphenyl phosphate;
wherein the polymer composition has a melt viscosity of 420 Pa·sec or less when measured at 260° C. and 1500 sec⁻¹, a tensile modulus of from about 3000 MPa to about 3800 MPa according to ASTM D638, and a notched Izod impact strength of about 400 J/m or greater when measured at 23° C. according to ASTM D256.

20. A polymer composition comprising:
a polycarbonate polymer;
an impact modifier comprising from about 2 to about 12 weight percent of the composition;
a non-glass filler comprising from about 5 to about 20 weight percent of the composition;
an alicyclic saturated hydrocarbon resin comprising from about 2 to about 8 weight percent of the composition;
an acrylate polymer; and
bisphenol-A bis(diphenylphosphate);
wherein the acrylate polymer and bisphenol-A bis(diphenylphosphate) together comprise from about 3 to about 20 weight percent of the composition; and
wherein the polymer composition has a melt viscosity of 300 Pa·sec or less, when measured at 260° C. and 1500 sec⁻¹; a tensile modulus of from about 3000 MPa to about 3800 MPa according to ASTM D638; and a notched Izod impact strength of about 400 J/m or greater when measured at 23° C. according to ASTM D256.
